(19) United States
(12) Patent Application Publication
(10) Pub. No.: US 2002/0082871 A1
(43) Pub. Date: Jun. 27, 2002

(54) System and method for providing online insurance information

(76) Inventors: Ted Younger, Rustburg, VA (US); Michael Bolt, Forest, VA (US); Jeff Kraber, Forest, VA (US); James Johnson, Madison Heights, VA (US); Dale DeWhitt, Forest, VA (US)

Correspondence Address: Kerry H. Owens, Hunton & Williams, Suite 1200, 1900 K Street, N.W., Washington, DC, 20006, US

(21) Appl. No.: 09/741,421

(22) Filed: Dec. 21, 2000

Related U.S. Application Data
(60) Provisional application No. 60/243,778, filed on Oct. 30, 2000.

(51) Int. Cl. G06F 17/60

(52) U.S. Cl. 705/4

(57) ABSTRACT

The invention provides a system and method for supplying commission information to insurance agents. In a provided embodiment, the system communicates online with authorized users to provide commission information based on various search parameters. An insurance information system resides on a host server for providing insurance information to an authorized user over a network. The insurance information system comprises authentication tools for confirming the identity of the authorized user, a database for storing insurance information submitted to the insurance information system, and web page display tools for displaying a plurality of web pages to an authorized user. The display tools comprising means for displaying a search page which allows an authorized user to enter search criteria for conducting a search, wherein the search criteria options include an agent identification number and a detailed results page for displaying commission information in accordance with the results of the search. The system also comprises searching tools for searching the database for commission information in accordance with the search criteria entered on the search page.

### CONTINUING DATA

This non-provisional application claims priority from provisional application Ser. No. 60/243,778 filed Oct. 30, 2000.

### FIELD OF THE INVENTION

The present invention relates to a system and method for providing online insurance information and in particular to a system and method for providing agent commission information online.

### BACKGROUND OF THE INVENTION

In the insurance industry, general agents are often authorized by a plurality of providers or carriers to sell insurance. The general agents often hire sales agents and receive and distribute commissions resulting from the sales made by the hired sales agents.

The amount of each commission may vary depending on the insurance carrier and local regulations. The sales agents hired by the general agent frequently request commission information from the general agent. The task of tracking commissions from multiple carriers for multiple agents can become onerous for the general agent.

Additionally, providing commission information upon request to each agent can become a burdensome task for the insurance carriers. Each call from an agent to an insurance carrier asking for commission information can result in extra costs to the insurance carrier.

Accordingly, a need exists for a system enabling general agents to obtain commission information upon request without causing the insurance carriers to incur costs upon each request. Furthermore, a need exists for providing hired sales agents with a system for obtaining commission information without causing additional cost and inconvenience to the general sales agents and insurance carriers. Currently, no such systems exist.

### SUMMARY OF THE INVENTION

In accordance with the purposes of the invention as embodied and broadly described herein, there is provided an insurance information system residing on a host server for providing insurance information to an authorized user over a network. The insurance information system comprises authentication tools for confirming the identity of the authorized user and a database for storing commission information submitted to the insurance information system. The insurance information system additionally comprises web page display tools for displaying a plurality of web pages to an authorized user, the display tools comprising means for displaying a search page which allows an authorized user to enter search criteria for conducting a search, wherein the search criteria options include at least a general agent identification number, a policy number, or a commissionable agent identification number. The system comprises searching tools for searching the database for commission information in accordance with the search criteria entered on the search page. The system additionally comprises a detailed results page for displaying commission information in accordance with the results of the search.

In another aspect, the invention comprises a method for providing online commission information over a network to authorized users. The method comprises receiving an agent identification number in order authenticate the authorized users and providing a search criteria page for allowing an authorized user to search agent commission information, wherein the authorized user can search based on at least one of a policy number, a general agent number, and a commissionable agent number. The method further comprises searching a database constructed with input from insurance carriers to obtain insurance commission information and providing the authorized user with commission information retrieved from the database search.

These and other features, objects, and advantages of the preferred embodiments will become apparent when the detailed description of the preferred embodiments is read in conjunction with the drawings attached hereto.

### BRIEF DESCRIPTION OF THE DRAWINGS

FIG. 1 is a block diagram illustrating an embodiment of an insurance information system connected over a network with authorized users and insurance carriers;

FIG. 2 is a block diagram illustrating components of the insurance information system;

FIG. 3 is a block diagram illustrating components of an authorized user system of an embodiment of the invention;

FIG. 4 is a drawing illustrating a search page for a full search mode of the invention;

FIG. 5 is a drawing illustrating a summary page of an embodiment of the invention;

FIG. 6 is a drawing illustrating a detail page of an embodiment of the invention;

FIG. 7 is a drawing illustrating a search page for a quick search mode of the invention;

FIG. 8 is a flow chart illustrating a method of providing insurance information in a full search mode of the invention;

FIG. 9 is a flow chart illustrating a method of selecting a search;

FIG. 10 is a flow chart illustrating a method of selecting a view in accordance with an embodiment of the invention;

FIGS. 11A-C are flow charts illustrating the steps involved in modifying a view in an embodiment of the invention; and

FIG. 12 is a flow chart showing the steps involved in viewing search results in accordance with an embodiment of the method of the invention.

### DETAILED DESCRIPTION OF THE PREFERRED EMBODIMENTS

Reference will now be made in detail to the present preferred embodiments of the invention, examples of which are illustrated in the accompanying drawings in which like reference numerals refer to corresponding elements.

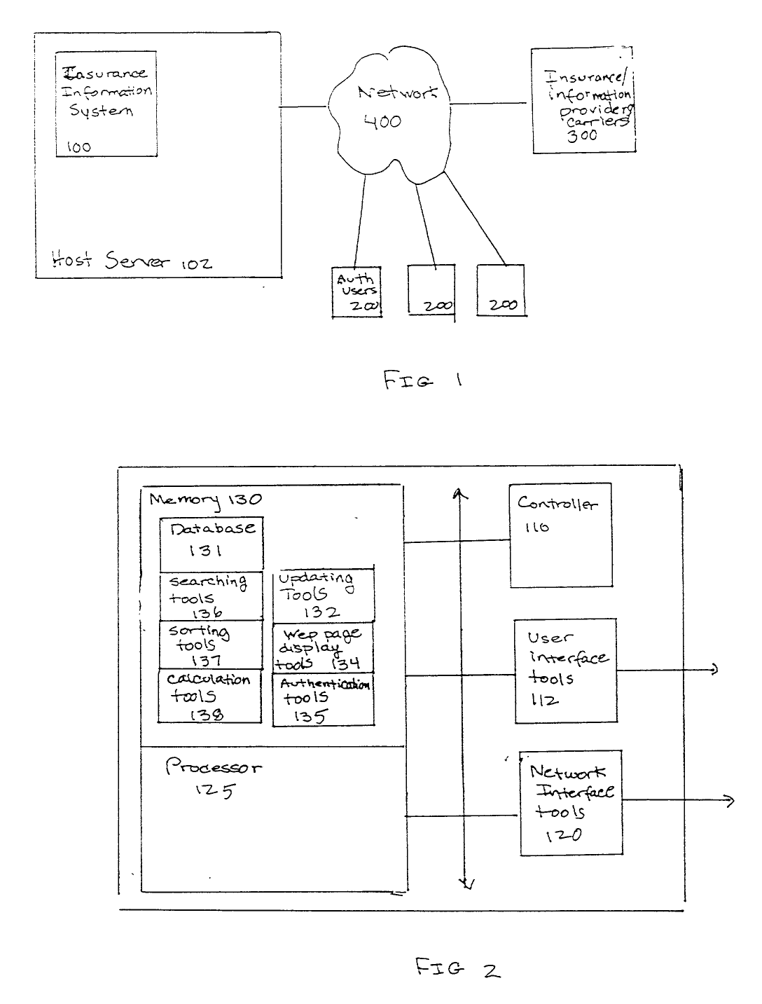

FIG. 1 is a block diagram illustrating an insurance information system 100 residing on a host server 102. The insurance information system 100 is connected over a network 400 with authorized users 200 and insurance or information carriers 300.

The host server 102 may be or include, for instance, a workstation running the Microsoft Windows™ NT™, Windows™ 2000, Unix, Linux, Xenix, IBM AIX™ Hewlett-Packard UX™, Novell Netware™, Sun Microsystems Solaris™, OS/2™ BeOS™, Mach, Apache, OpenStep™ or other operating system or platform.

The insurance or information carrier or carriers 300 are shown as being linked to the insurance information system 100 over the network 400. However, the carriers 300 may connect in any suitable manner with the insurance information system 100 in order to update information. Reports from carriers 300 could be provided to a host server administrator and subsequently manually uploaded. In a proposed technique, the initial data is loaded via tape and subsequent updates are electronically transferred and loaded into a insurance system database, which is further described below.

The network 400 preferably comprises the Internet and the authorized users 200, insurance or information carriers 300, and the host server 102 may communicate with the network 400 in any well known manner. The communications links may be, include or interface to any one or more of, for instance, the Internet, an intranet, a PAN (Personal Area Network), a LAN (Local Area Network), a WAN (Wide Area Network) or a MAN (Metropolitan Area Network), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34 bis analog modem connection, a cable modem, an ATM (Asynchronous Transfer Mode) connection, or an FDDI (Fiber Distributed Data Interface) or CDDI (Copper Distributed Data Interface) connection. The communications link may furthermore be, include or interface to any one or more of a WAP (Wireless Application Protocol) link, a GPRS (General Packet Radio Service) link, a GSM (Global System for Mobile Communication) link, a CDMA (Code Division Multiple Access) or TDMA (Time Division Multiple Access) link such as a cellular phone channel, a GPS (Global Positioning System) link, CDPD (cellular digital packet data), a RIM (Research in Motion, Limited) duplex paging type device, a Bluetooth radio link, or an IEEE 802.11-based radio frequency link. Communication may also be commplished by any one or more of an RS-232 serial connection, an IEEE-1394 (Firewire) connection, a Fibre Channel connection, an IrDA (infrared) port, a SCSI (Small Computer Systems Interface) connection, a USB (Universal Serial Bus) connection or other wired or wireless, digital or analog interface or connection.

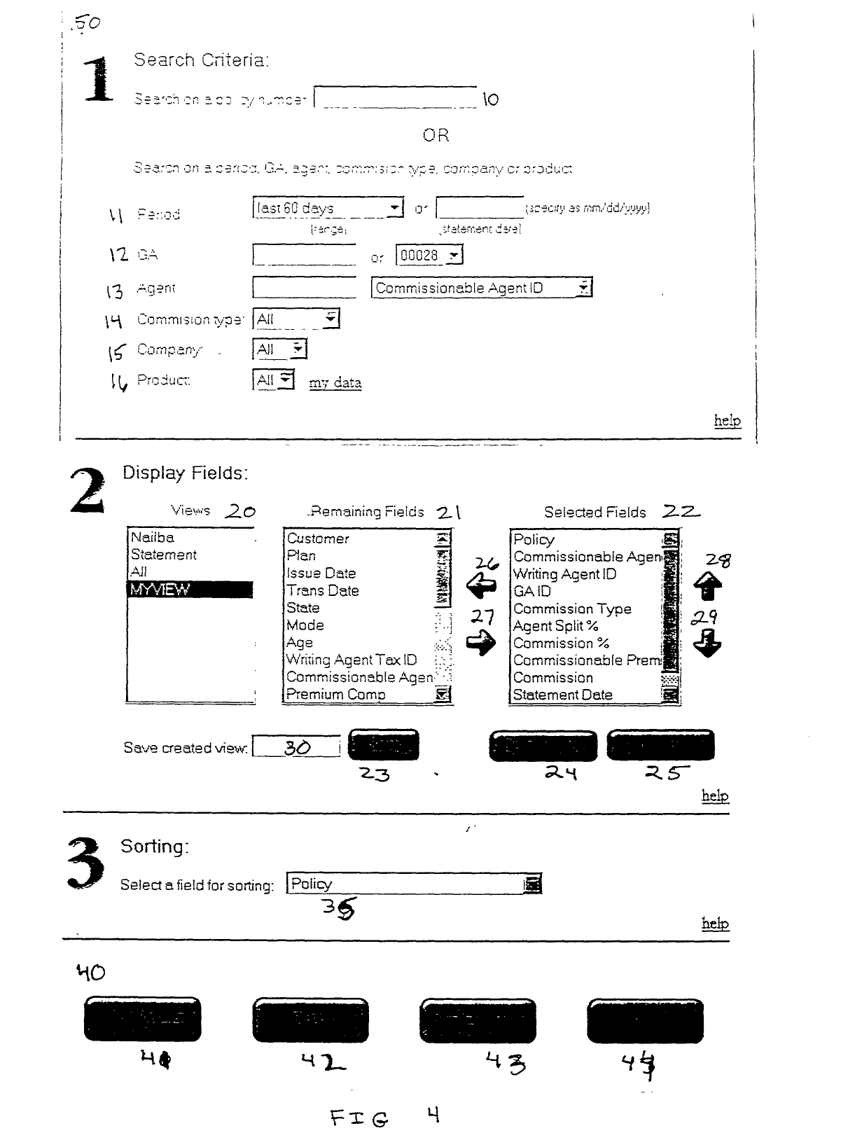

An embodiment of the authorized user system 200 is shown in FIG. 3. The displayed embodiment includes a controller 202, a user interface device 204 such as a mouse, monitor, or keypad, a network interface 206, a processor 208, and a memory 210. The authorized user 200 may take any known form, such as a personal computer running the Microsoft Windows™ 95, 98, Millenium™, NT™, or 2000, WindowsTMCE™, PalmOS™, Unix, Linux, Solaris™, OS/2™, BeOS™, MacOS™ or other operating system or platform. The processor 208 may include a microprocessor such as an Intel x86-based device, a Motorola 68K or PowerPC™ device, a MIPS, Hewlett-Packard Precision™, or Digital Equipment Corp. Alpha™ RISC processor, a microcontroller or other general or special purpose device operating under programmed control. The memory 210 may include electronic memory such as RAM (random access memory) or EPROM (electronically programmable read only memory), storage such as a harddrive, CDROM or rewritable CDROM or other magnetic, optical or other media, and other associated components connected over an electronic bus, as will be appreciated by persons skilled in the art. The network interface 206 may be or include a network-enabled appliance such as a WebTVTM unit, radio-enabled Palm™ Pilot or similar unit, a browser-equipped cellular telephone, or other TCP/IP client or other device.

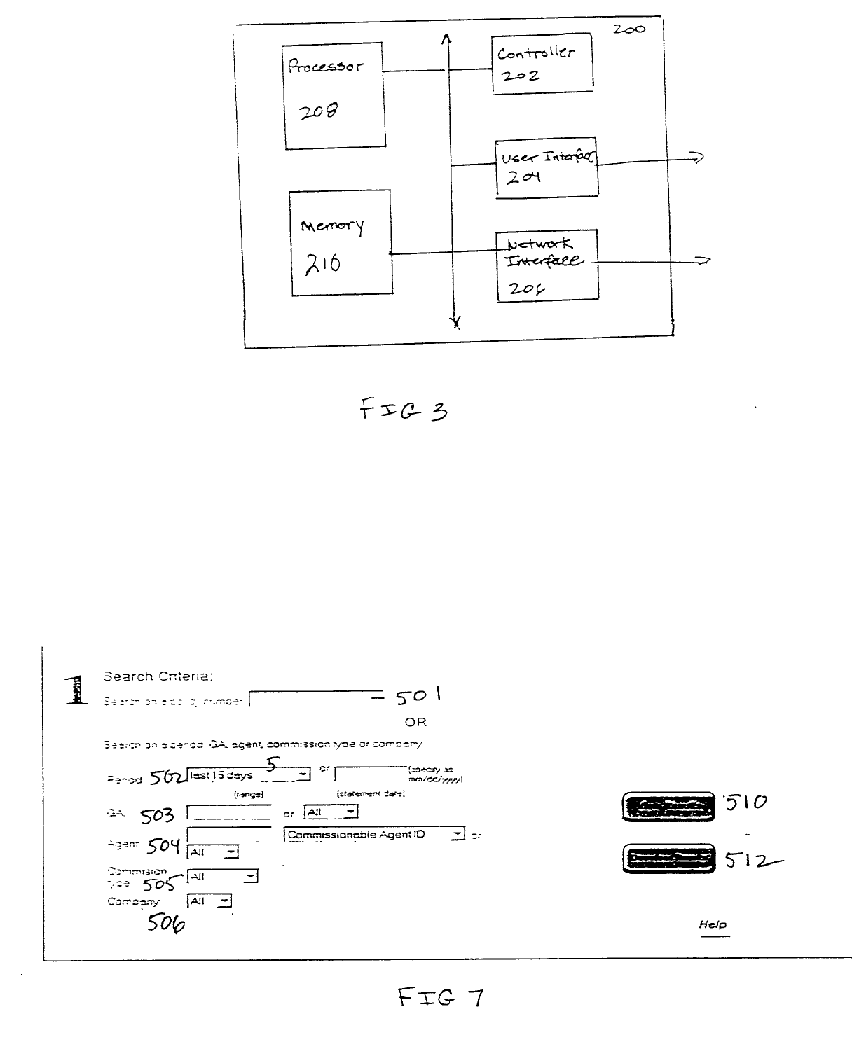

The insurance information system 100 is shown in greater detail in FIG. 2. In the displayed embodiment, the insurance information system includes or interacts with a controller 110, user interface tools 112, network interface tools 120, a processor 125 and a memory 130. Tools for implementing the insurance information system may be stored in the memory 130.

A database 131 is constructed with the input of the insurance carriers 300. Once constructed, the database includes information detailing commission information for a plurality of insurance agents. Updating tools 132 allow the database 130 to be continually updated by the insurance carriers 300 or by any entities having the authority to provide such updates. The database 131 may be, include or interface to, for example, the Oracle™ relational database sold commercially by Oracle Corp. Other databases, such as Informix™, DB2 (Database 2), Sybase or other data storage or query formats, platforms or resources such as OLAP (On Line Analytical Processing), SQL (Standard Query Language), a storage area network (SAN), Microsoft Access™ or others may also be used, incorporated or accessed in the invention.

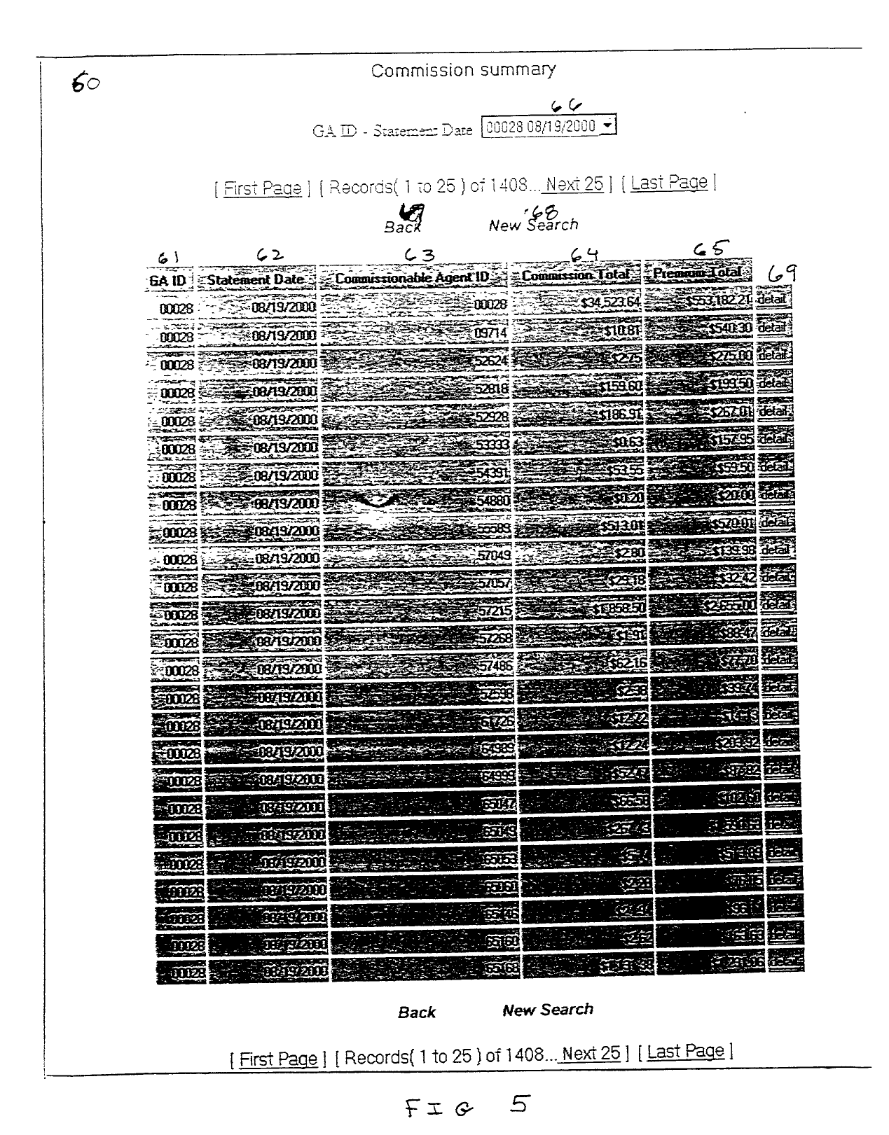

Web page display tools 134 provide web pages to the authorized users 200 to simplify user interaction. The provided web pages include at least a search page, a summary page, and a detail page, all of which are further described below in conjunction with FIGS. 4-7.

Authentication tools 135 are used to ensure that a user attempting to obtain access is an authorized user 200. Preferably, authorized users 200 will be required to authenticate themselves through the use of a general agent or agent identification number in combination with a company code and a user ID. Preferably, the authtone model is employed. This model passes a user object containing the identification numbers and company code to the insurance information system 100 upon logon. The object authorizes the user 200 to view commissions data. A single user may have multiple identifications numbers and company codes linked to its user ID. In this manner, when an authorized user 200 initiates an inquiry, the authorized user 200 interacts with the communications tools 135 which extract all records for which there is a match between the user object and the records containing the agent identification number and company codes. Only the data which has the corresponding agent identification number and company code will be accessible to that particular authorized user 200.

The insurance information system 100 further comprises searching tools 136 that are used by the authorized user 200 to search for desired data contained within the database 131. Such data is generally commissions data relevant to the authorized user. Sorting tools 137 sort the commissions data into an appropriate format in accordance with the request of the authorized user 200.

The insurance system 100 may further comprise calculation tools 138 which perform mathematical operations to obtain commissions statistics in accordance with the request of an authorized user 200.

If an authorized user 200 uses the authentication tools 135 and obtains access to the system 100, the user 200 is presented with search options. A first search option is the full search option, which can be implemented using a web page 50 as shown in FIG. 4. Section 1 of the web page 50 provides the search criteria. A data entry area 10 can be used to search a policy number. A data entry area 11 provides a mechanism for searching over a specific time period. General agents enter identification numbers in a data entry area 12. Commissionable agents enter the conmmissionable agent ID number in data entry area 13. A data entry area 14 provides a variety of commission types. A data entry area 15 displays multiple companies, and finally a data entry area 16 displays product options.

In section 2 of the search page 50, the authorized user 200 is able to select a specific view in accordance with a selection box 20. The options shown in selection box 20 include National Association of Independent Life Brokerage Agencies (NAILBA), statement, all, and MYVIEW, which is a customized, user defined view. The MYVIEW option shown is for purposes of illustration only and generally only the first three of the aforementioned options are provided. The customized views are created generally through starting with the “all” view option and deleting unnecessary fields from the selected fields. This process is further explained below with reference to the provided flow charts. If the authorized user 200 elects to create a customized view such as the MYVIEW option, the authorized user 200 must define the customized view using selection boxes 21 and 22, which display remaining fields and selected fields respectively. The authorized user 200 can use arrows 26 and 27 between the columns 21 and 22 for moving fields from the remaining fields column 21 to the selected fields column 22. To change the order of the displayed fields, the authorized user 200 may click on a field in column 22 and use arrows 28 and 29. In order to save a user created view, the authorized user 200 enters a name for the view in the data entry box 30 and presses the save button 23. The authorized user 200 may delete and update views using delete view button 24 and update view button 25.

Section 3 of the search web page 50 provides a data entry box 35 for entering a sort field. The field that is selected for sorting must be one of the fields that is provided in the selected fields column 22. The selection of a sort field determines the format in which transaction details will be viewed.

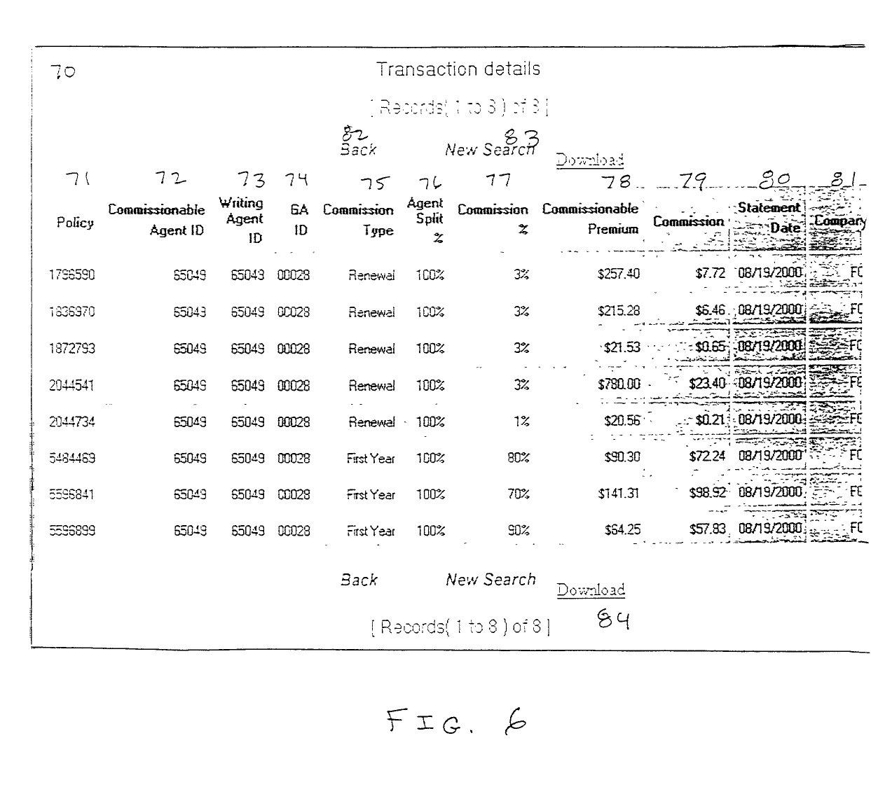

After the authorized user 200 has entered all desired data and selected all desired views, the authorized user 200 may select to view results by selecting a view results button 41. A summary page such as that shown in FIG. 5 will then be displayed. A reset button 42 resets the contents of the search form to predetermined default settings. A download results button 43 downloads transaction details in a semi-colon delimited ASCII format. A downloaded fields will be all of those contained in the view selected. A download results NAILBA format button 44 downloads the transaction details in NAILBA commissions download format. To download a NAILBA file, a statement date, company, and general agent identification number must be specified.

As shown in FIG. 5, when the authorized user 200 performs a full search, a summary report 60 is provided in accordance with the selected views. In the example of FIG. 5, the summary report 60 includes a general agent ID column 61, a statement date column 62, a commissionable agent ID column 63, a commission total column 64, and a premium total column 65. The summary page 60 further includes a detail link in column 69 for each entry. The summary page 60 further includes tools 67 for moving from page to page. A new search option 68 provides the user with a link back to the search page 50.

If the authorized user 200 selects to link with a detail from column 69, the authorized user 200 is presented with the detail page 70 as shown in FIG. 6. The detail page 70 shows all requested data for a particular commissionable agent and general agent on a particular date. A policy column 71 shows the policy number. A commissionable agent ID column 72 shows the commissionable agent ID number. A writing agent ID column 73 shows the writing agent ID number. A general agent ID column 74 provides the general agent ID number. A commission type column 75 provides information as to whether the policy is a new policy or a renewal. An agent split column 76 provides information as to what the split percentage is between agents. Commission column 77 provides the agent's commission percentage. A commissionable premium column 78 provides the dollar amount on which the commission is based. A commission column 79 provides the dollar amount of the commission. A statement date column 80 provides the date of the statement and a company column 81 provides an insurance company name. Within the details page 70, navigation buttons including a back button 82 and a new search button 83 are provided. A download button 84 provides a complete spreadsheet download of all of the information displayed in the selected view.

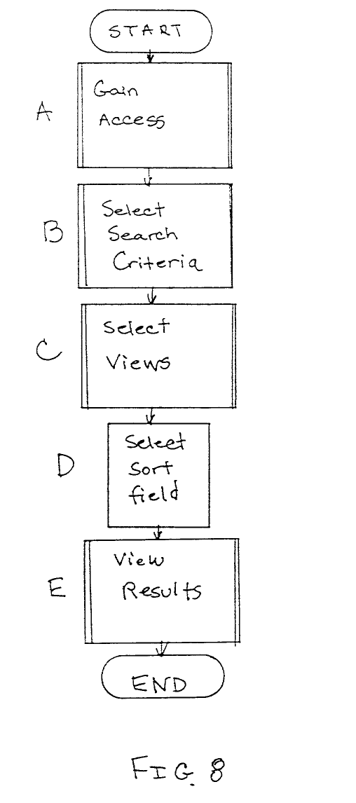

FIG. 7 illustrates a quick search page 500. Three different types of quick searches are available. An authorized user 200 may execute a first type of quick search by performing a search on a policy number by entering the number in data entry space 501. Alternatively, the authorized user 200 may perform a quick search by general agent. In this instance, the authorized user 200 selects the period range from data space 502 or selects a specific commission statement date. The authorized user 200 then fills in or selects the general agent number in space 502. Furthermore, in this second quick search mode, the authorized user 200 must select the commission type, preferably as being one of “1st year”, “renewal”, and “all” in space 505, and select the company field which in the displayed embodiment includes American Mayflower Life (AML) and First Colony Life (FCL), and “all” in space 506. After the data is entered, an authorized user may view results by selecting the results button 510 and may download results using button 512. A third quick search technique involves searching by agent. As with the second technique, data must be selected or entered in spaces 502, 505, and 506. However, the general agent space 503 can be left empty and the agent space 504 must be completed. In order to complete the agent space 504, the authorized user 200 must enter the agent number and use a drop down box to select a type of agent identification, which preferably includes: commissionable agent ID; agent tax ID; agent tax ID; writing agent ID; or writing agent tax ID.

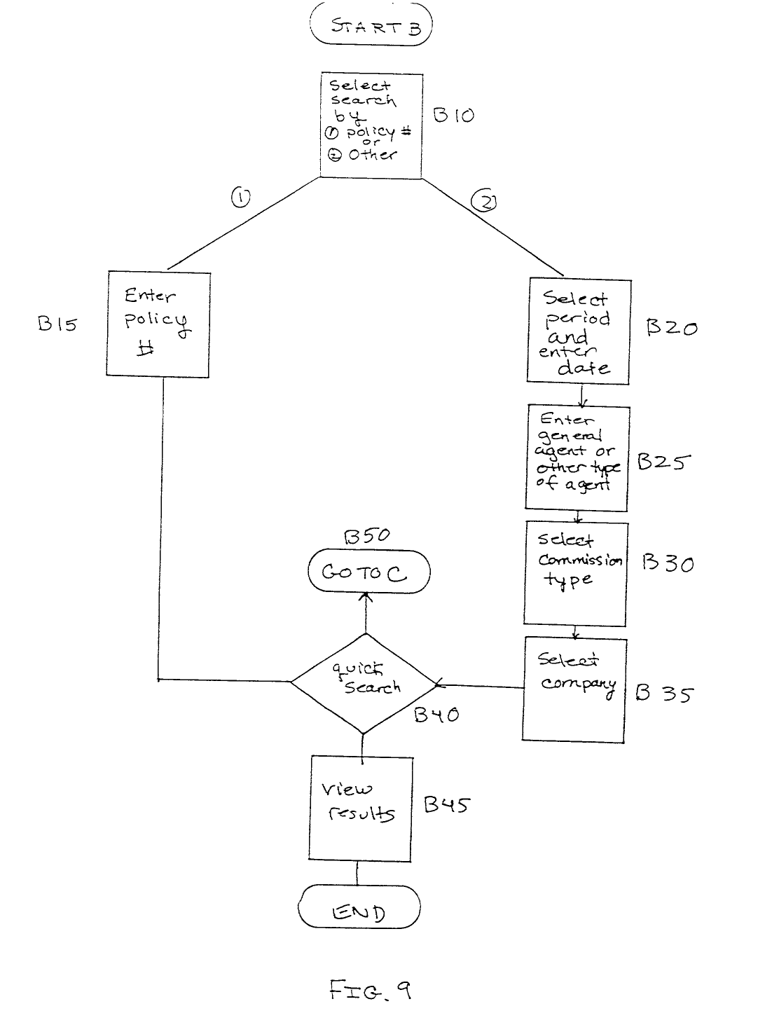

FIG. 8 illustrates a method of performing a search in accordance with an embodiment of the invention. In procedure A, an authorized user gains access to the system. In procedure B, an authorized user 200 uses the web page 50 as shown in FIG. 4 and as provided by the web page display tools 134 to select search criteria. In procedure C, the authorized user 200 selects views as provided in section 2 of the web page 50. In step D, the authorized user 200 selects a sort field. Finally, in procedure E, the authorized user 200 views results provided by the searching tools 136 and sorting tools 137.

Procedure A, as described above, generally involves the entry of a general agent identification number and company code. Upon logon, the user's identity is authenticated by the authentication tools 135. The user 200 may be limited to a specific predetermined number of logon attempts.

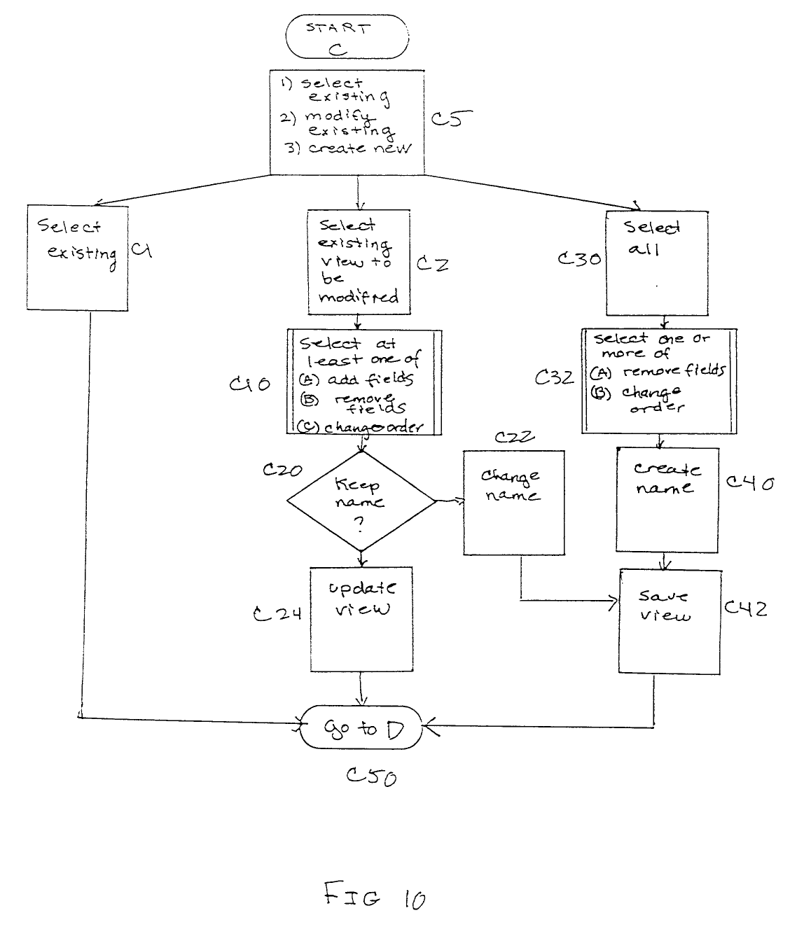

FIG. 9 illustrates the details of procedure B. In step B10, the authorized user 200 elects to search by (1) policy number or by (2) any other criteria. If the authorized user 200 elects to search by policy number, the user 200 enters the policy number in step B15. If the authorized user 200 elects to perform the search based on other criteria, the authorized user 200 selects a time period or enters a date in step B20. In step B25, the authorized user 200 enters the general agent data or alternatively, data for another type of agent. In step B30, the authorized user 200 selects the commission type sought. In step B35, the authorized user 200 selects the company from a pull down list of companies.

If the user desires a quick search in step B40, the user can select the view results button to obtain results in step B45 which will be viewed in accordance with default settings. Alternatively, if the authorized user 200 would like to select views, the user 200 can proceed to procedure C in order to select the desired views.

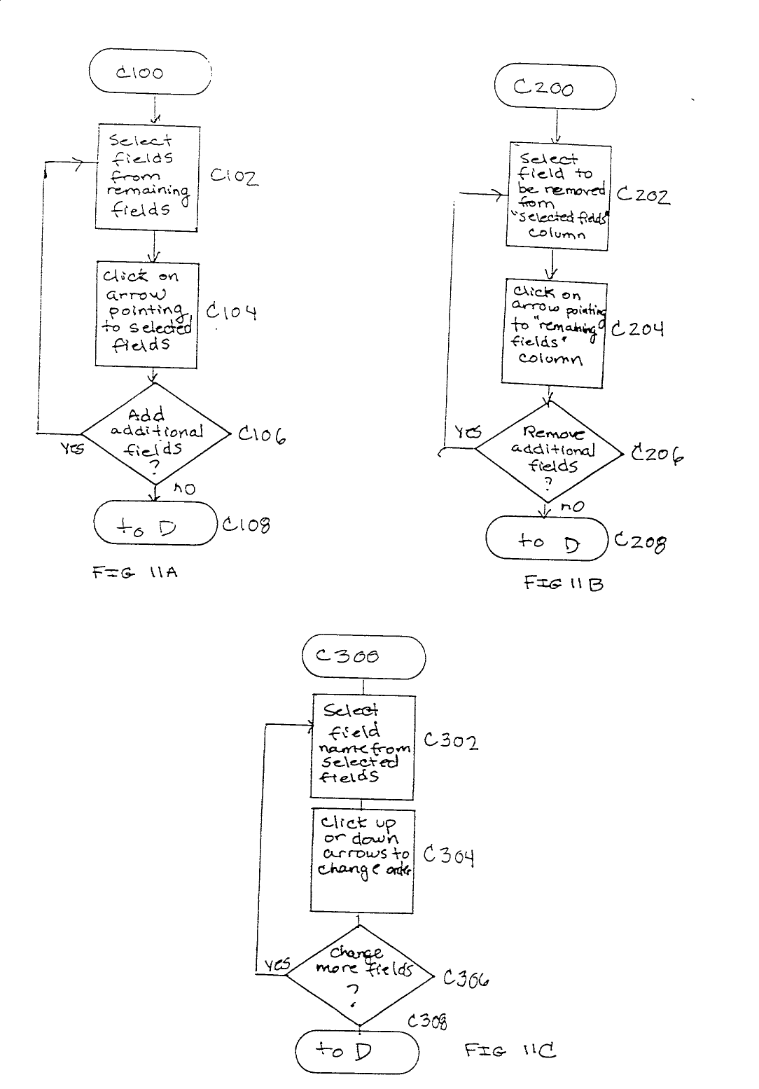

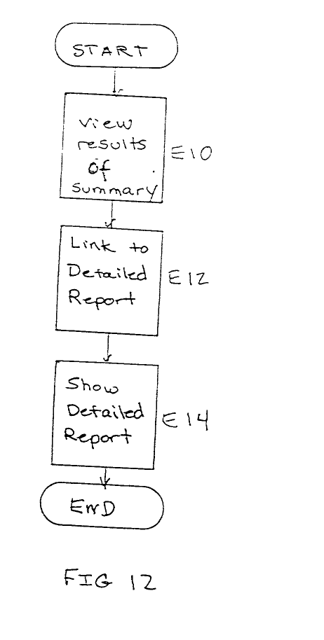

In FIG. 10, the authorized user 200 has the option in step C5 to: (1) select an existing view; (2) modify an existing view; or (3) create a new view. If the user selects an existing view in step C1, the user 200 can then proceed to step D to select a sort field. If the user elects to modify an existing view in step C2, the user 200 selects at least one of: (a) adding fields; (b) removing fields; and (c) changing the order of the displayed fields. FIGS. 11A-11C depict the aforementioned options and will be described in detail below. In step C20, the user 200 decides whether to keep the current view name. If the user 200 elects to change the view name, the user 200 enters a new name in step C22 and saves the new name in step C42. Alternatively, if the old name is retained, the authorized user 200 clicks on the update view button in step C24. If the authorized user 200 selects option (3) of creating a new view, the user 200 selects “all” from in step C30. In step C22, the authorized user 200 selects one or more of (a) removing fields; and (b) changing the order of the fields as further described below in conjunction with FIGS. 11A-11C. In step C40, the authorized user 200 selects a new name for the view. In step C42, the user 200 saves the view, and in step C50, the authorized user 200 proceeds to step D. Step D entails selecting a sort variable to determine how the results will be sorted by the sorting tools 137.

FIGS. 11A-11C illustrate the view modification methods of an embodiment of the invention. Procedure C100 illustrates the procedure of adding fields to the view. In step C102, the authorized user 200 selects fields to be added from the remaining fields column 21 of web page 50. In step C104, the authorized user 200 utilizes arrow 27 to move the highlighted remaining field to the selected fields column 22. If additional fields are to be added to the view, step C106 begins the loop of repeating the aforementioned steps.

FIG. 11B illustrates the procedure C200 of removing fields from the view. In step C202, the authorized user 200 selects the field to be removed from the selected fields column C202. In step C204, the authorized user 200 clicks on arrow 26 to move the highlighted selected field to the remaining fields column 21. Finally, in step C206, if additional fields are to be deleted from the review, the loop of the aforementioned steps is repeated.

FIG. 11C illustrates the steps involved in changing the order of the fields. In step C302, the authorized user 200 selects the field name to be moved from the selected fields column 22. In step C304, the user 200 clicks on the up of down arrows 28 and 29 to move the selected field. Finally, in step 306, if more fields are to be moved, the loop of steps 302 and 304 is repeated. Once the user 200 has moved all fields as desired, the insurance information system 100 displays results in accordance with procedure E as shown in FIG. 12.

The insurance information system 100 displays results when the authorized user 200 selects the view results button 41. If a full search has been implemented, the insurance information system produces a summary page as shown in FIG. 5, which includes a link in column 69 to detailed results. Upon selection of detailed results in step E12, the insurance information system 100 displays the detailed results page in step E14 to the authorized user 200 as shown in FIG. 12.

It will be apparent to those skilled in the art that various modifications and variations can be made in the system and process of the present invention without departing from the spirit and scope of the invention. Thus, it is intended that the present invention cover the modifications and variations provided they come within the scope of the appended claims and their equivalents.

What is claimed is:

1. An insurance information system residing on a host server for providing insurance information to an authorized user over a network, the insurance information system comprising:
authentication tools for confirming the identity of the authorized user;
a database for storing insurance information submitted to the insurance information system;
web page display tools for displaying a plurality of web pages to an authorized user, the display tools comprising means for displaying a search page which allows an authorized user to enter search criteria for conducting a search, wherein the search criteria options include an agent identification number and a detailed results page for displaying commission information in accordance with the results of the search; and
searching tools for searching the database for commission information in accordance with the search criteria entered on the search page, wherein the web page display tools further display search results;

2. The insurance information system of claim 1, wherein the web page display tools further comprise means for providing a summary page having links to a detailed results page.

3. The insurance information system of claim 1, wherein the web page display tools comprise means for displaying a plurality of views, each of said views comprising a plurality of fields.

4. The insurance information system of claim 3, wherein one of said views is a customized view selectable by the authorized user.

5. The insurance information system of claim 4, wherein web page display tools comprise means for modifying the customized view.

6. The insurance information system of claim 3, wherein the web page display tools comprise means for modifying all views.

7. The insurance information system of claim 1, wherein the searching tools comprise means for searching commission information based on at policy number, time period, and agent number.

8. The insurance information system of claim 1, wherein the searching tools comprise means for searching commission information based on at least one of commission type, company, and product.

9. The insurance information system of claim 1, further comprising sorting tools for determining the format in which transaction details will be viewed.

10. A method for providing online commission information over a network to authorized users, the method comprising:
receiving an agent identification number in order authenticate the authorized users;
providing a search criteria page for allowing an authorized user to search agent commission information, wherein the authorized user can search based on at least one of a policy number and a general agent number, and a commissionable agent number;
searching a database constructed with input from insurance or information carriers to obtain insurance commission information; and
providing the authorized user with commission information retrieved from the database search.

11. The method of claim 10, wherein the step of providing the authorized user with commission information comprises the sub-step of displaying a summary page having a link to a detail page.

12. The method of claim 10, further comprising allowing the authorized user to select a view, wherein each view comprises a plurality of fields.

13. The method of claim 12, further comprising the sub-step of offering the authorized user the option to create additional views and modify existing views.

14. The method of claim 12, wherein creating additional views and modifying existing views comprise performing at least one of adding fields, removing fields, and re-ordering fields.

15. The method of claim 14, wherein adding fields comprises selecting a field from a remaining fields column and clicking on an arrow pointing to an selected fields column.

16. The method of claim 14, wherein removing fields comprises selecting a field from a selected fields column and clicking an arrow pointing to a remaining fields column.

17. The method of claim 14, wherein re-ordering fields comprises selecting a field name from a selected fields column and clicking on an up or down arrow to re-order.

18. The method of claim 10, further comprising the step of providing transaction details, the details being sorted according to a selected field.
